(19) United States
(12) Patent Application Publication
(10) Pub. No.: US 2012/0106773 A1
(43) Pub. Date: May 3, 2012

(54) SPEAKER DEVICE AND METHOD FOR FORMING SPEAKER DEVICE

(75) Inventors: Nobukazu Suzuki, Kanagawa (JP); Yoshio Ohashi, Kanagawa (JP)

(73) Assignee: SONY CORPORATION, Tokyo (JP)

(21) Appl. No.: 13/381,551

(22) PCT Filed: Jul. 20, 2010
(86) PCT No.: PCT/JP10/62486

§ 371 Date: Dec. 29, 2011

(30) Foreign Application Priority Data
Jul. 23, 2009 (JP) 2009-171800

(51) Int. Cl. H04R 11/02; H04R 31/00

(52) U.S. Cl. 381/399; 29/896.23

(57) ABSTRACT

A speaker device which can form an ideal cylindrical wave as sound traveling nondirectionally in a horizontal direction toward a listener. A vibration transmitting member is supported at one end thereof to the vertex of a conical diaphragm, and vibration generated by a vibrating element according to an acoustic signal is applied to the other end of the vibration transmitting member. The angle θ between the perpendicular dropped from the vertex of the conical diaphragm to the base thereof and the side surface of the conical diaphragm is set according to the sound velocity in the air and the sound velocity in the conical diaphragm so that the distance traveled by a sound radiated from the vertex is equal to the distance traveled by a sound radiated from an end of the side surface of the conical diaphragm farthest from the vertex.

### TECHNICAL FIELD

The present invention relates to a speaker device having an excitation type configuration such that vibration generated according to an acoustic signal by an actuator such as a super magnetostrictive actuator is transmitted to an acoustic diaphragm, thereby generating sound, and also relates to a method of forming this speaker device.

### BACKGROUND ART

As s speaker device rather than an ordinary speaker unit having a voice coil and a cone, there has been proposed and put to practical use a speaker device such that vibration is applied from an actuator such as a super magnetostrictive actuator to an acoustic diaphragm formed of acrylic resin, thereby generating sound from the acoustic diaphragm.

More specifically, Patent Document 1 discloses a speaker device having a cylindrical acoustic diaphragm vertically supported and a plurality of magnetostrictive actuators arranged on the lower side of the acoustic diaphragm, wherein a driving rod of each magnetostrictive actuator abuts against the lower end surface of the acoustic diaphragm to apply axial vibration to the acoustic diaphragm.

In this speaker device, the lower end surface of the cylindrical diaphragm is excited to immediately propagate compression wave in the longitudinal direction of the cylindrical diaphragm. During the course of propagation of this compression wave, a force in the radial direction of the cylindrical diaphragm (in the direction perpendicular to the longitudinal direction of the cylindrical diaphragm) is generated according to a Poisson ratio inherent in a solid. Accordingly, this force causes radial vibration in the cylindrical diaphragm, so that sound wave is generated from the whole of the cylindrical diaphragm.

The Poisson ratio means the ratio between expansion or contraction in a direction of application of a force and contraction or expansion in a direction perpendicular to the direction of application of the force when the force is applied to an elastic body to expand or contract the elastic body.

In this speaker device, sound wave is radiated from the acoustic diaphragm at any axial position thereof at a uniform level, thereby forming a uniform sound image over the height (length) of the acoustic diaphragm. That is, a high-quality reproduced sound field can be realized.

Patent Document 2 discloses an invention relating to a speaker such that a signal (vibration) generated by an actuator according to an acoustic signal is transmitted to a diaphragm formed of paper to generate sound from the diaphragm.

The actuator described in Patent Document 2 is realized as a driving section box, which includes a voice coil and a disk for receiving a force by the voice coil, the disk being provided in a vibration suppressed condition.

The force to be applied to the disk is generated by supplying an electric signal to the voice coil, and wave due to this force is transmitted through a support column or the like to the paper (diaphragm), thereby vibrating the paper to radiate sound.

In the speaker device described in Patent Document 2, a voice coil and a cone need not to be arranged close to each other unlike a conventional speaker device. Accordingly, the flexibility in structure and arrangement can be improved.

### PRIOR ART DOCUMENTS

### Patent Documents

Patent Document 1: Japanese Patent Laid-open No. 2007-166027
Patent Document 2: Japanese Patent Laid-open No. 2000-350285

### SUMMARY OF INVENTION

In the speaker device disclosed in Patent Document 1, compression wave propagates instantaneously at a sound velocity in a solid. However, in a strict sense, no sufficient consideration is given to the time of sound wave radiation at an excitation point on the diaphragm and the time of sound wave radiation at a point farthest from the excitation point.

That is, sound is radiated immediately from near the excitation point on the diaphragm, whereas slight time is taken until vibration from the excitation point is transmitted to the point farthest from the excitation point.

Accordingly, in the invention described in Patent Document 1, a sound wave front radiated from the whole of the diaphragm becomes a wave front having an angle a depending upon a sound velocity in the material of the diaphragm (the velocity of longitudinal wave propagating in a solid (in the diaphragm)).

FIG. 17A is a front elevation of this speaker device having an acoustic diaphragm 100 formed of acrylic resin, for example, and a vibrating element (actuator) 200 provided at the lower end of the acoustic diaphragm 100, wherein vibration according to an acoustic signal is applied from the vibrating element 200 to the acoustic diaphragm 100.

In this case, sound is immediately radiated from a lower portion of the acoustic diaphragm in the vicinity of the excitation point, whereas sound is radiated from an upper portion of the acoustic diaphragm distant from the excitation point with a slight time delay.

Accordingly, as shown in FIG. 17B which is a side elevation of FIG. 17A, the wave front of sound radiated from the entire front surface of the acoustic diaphragm 100 becomes a wave front Au shown by a solid line having an angle α formed with respect to a plane parallel to the front surface of the acoustic diaphragm 100 shown by a broken line.

The same holds true with regard to the speaker device described in Patent Document 2. That is, also in the speaker device described in Patent Document 2, vibration is applied to the lower side of the paper forming the acoustic diaphragm.

Accordingly, as in the speaker device described in Patent Document 1, it is considered that a slight difference in sound radiation timing is produced between a portion of the paper forming the acoustic diaphragm near the excitation point and a portion distant from the excitation point in the speaker device described in Patent Document 2.

In the speaker device described in Patent Document 2, the paper forming the acoustic diaphragm is elastically deformed in the condition where internal stress is present. It is difficult to control sound radiation so that a sound wave front parallel to the acoustic diaphragm is formed, because of the complicated shape of the acoustic diaphragm.

In considering the speaker device described in Patent Document 1 as a premise, it is insufficient to merely form a sound wave front parallel to the acoustic diaphragm. That is, it is desirable to realize a speaker device which can form an ideal cylindrical wave as sound traveling nondirectionally in a horizontal direction toward a listener.

It is accordingly an object of the present invention to form an ideal cylindrical wave traveling nondirectionally in a horizontal direction toward a listener as the sound radiated from a speaker device.

In accordance with the invention as defined in claim 1, there is provided a speaker device including an acoustic diaphragm having a conical shape such that a perpendicular dropped from a vertex to a base passes through the center of the base; a vibrating element for receiving an acoustic signal to be reproduced and generating vibration according to the acoustic signal; and a vibration transmitting member having one end supported to the vertex of the acoustic diaphragm and the other end to be excited by the vibrating element; wherein the angle θ between the perpendicular dropped from the vertex of the acoustic diaphragm to the base of the acoustic diaphragm and a side surface of the acoustic diaphragm is set so that the distance traveled by a sound radiated from the vertex of the acoustic diaphragm is equal to the distance traveled by a sound radiated from an end of the side surface of the acoustic diaphragm farthest from the vertex of the acoustic diaphragm with the same timing as that of the sound radiated from the vertex.

According to the speaker device of the invention as defined in claim 1, the vibration transmitting member is supported at one end thereof to the vertex of the conical acoustic diaphragm, and vibration generated by the vibrating element according to an acoustic signal is applied to the other end of the vibration transmitting member. That is, the vibration from the vibrating element is transmitted through the vibration transmitting member to the vertex of the conical acoustic diaphragm.

In the conical acoustic diaphragm, the angle θ between the perpendicular dropped from the vertex of the acoustic diaphragm to the base thereof and the side surface of the acoustic diaphragm is set so that the distance traveled by the sound radiated from the vertex of the acoustic diaphragm is equal to the distance traveled by the sound radiated from the end of the side surface of the acoustic diaphragm farthest from the vertex of the acoustic diaphragm with the same timing as that of the sound radiated from the vertex.

Accordingly, the sound radiated from the acoustic diaphragm becomes an ideal cylindrical wave traveling nondirectionally in a horizontal direction toward a listener, so that a good nondirectional reproduced sound field for the listener can be provided.

According to the present invention, the conical acoustic diaphragm can form an ideal cylindrical wave as sound traveling nondirectionally in a horizontal direction toward the listener. Accordingly, a good nondirectional reproduced sound field for the listener can be provided.

### BRIEF DESCRIPTION OF DRAWINGS

FIG. 1 is a view for illustrating the external appearance of an excitation type speaker device according to a first embodiment to which a preferred embodiment of a device and method of the present invention is applied.

FIG. 2 is a side view of the speaker device according to the first preferred embodiment shown in FIG. 1.

FIG. 3 is a diagram for illustrating how to obtain the angle θ between the axis AD of a conical diaphragm 1 and the edge AC of the side surface of the conical diaphragm 1.

FIG. 4 is a view for illustrating a modification of the speaker device according to the first preferred embodiment.

FIG. 5 is a side view for illustrating a sound wave front generated by the speaker device according to the first preferred embodiment as viewed in side elevation of the speaker device.

FIG. 6 is a top plan view for illustrating the sound wave front generated by the speaker device according to the first preferred embodiment as viewed in top plan of the speaker device.

FIG. 7 is views for illustrating the configuration of a super magnetostrictive actuator used as a vibrating element 3.

FIG. 8 is a view for illustrating a specific configuration of the speaker device according to the first preferred embodiment.

FIG. 9 is a view for illustrating the case of upward inclining the traveling direction of the sound wave front of sound radiated from the conical diaphragm 1.

FIG. 10 is a view for illustrating the case of downward inclining the traveling direction of the sound wave front of sound radiated from the conical diaphragm 1.

FIG. 11 is a view for illustrating an excitation type speaker device according to a second preferred embodiment of the present invention.

FIG. 12 is a view for illustrating a speaker device employing only a conical diaphragm 1a whose base is oriented upward.

FIG. 13 is a view for illustrating a speaker device according to a first example of a third preferred embodiment.

FIG. 14 is a graph for illustrating the vibration characteristics of magnesium and paper.

FIG. 15 is a view for illustrating a speaker device according to a second example of the third preferred embodiment.

FIG. 16 is a view for illustrating a speaker device according to a third example of the third preferred embodiment.

FIG. 17 is views for illustrating an excitation type speaker in the existing art.

### MODES FOR CARRYING OUT THE INVENTION

There will now be described some preferred embodiments of the speaker device and the forming method therefor according to the present invention with reference to the drawings. The speaker device in each preferred embodiment is of a so-called excitation type including an acoustic diaphragm, a vibration transmitting member, and a vibrating element (actuator) as fundamental components.

The speaker device in each preferred embodiment is so configured as to be focused on the following three factors, i.e., the shape of the acoustic diaphragm, the position of an excitation point in the acoustic diaphragm, and the material (sound velocity etc.) of the vibration transmitting member. That is, by optimizing these three factors, a nondirectional speaker device capable of forming an ideal cylindrical wave is realized.

First to third preferred embodiments of the speaker device and the forming method therefor according to the present invention will now be described specifically.

In this description, the wording of “acoustic” broadly means “sound.” That is, the wording of “acoustic” used in this description includes human voice, musical sound, and other various “sounds” that can be propagated by vibration and heard by the human ear.

### First Preferred Embodiment

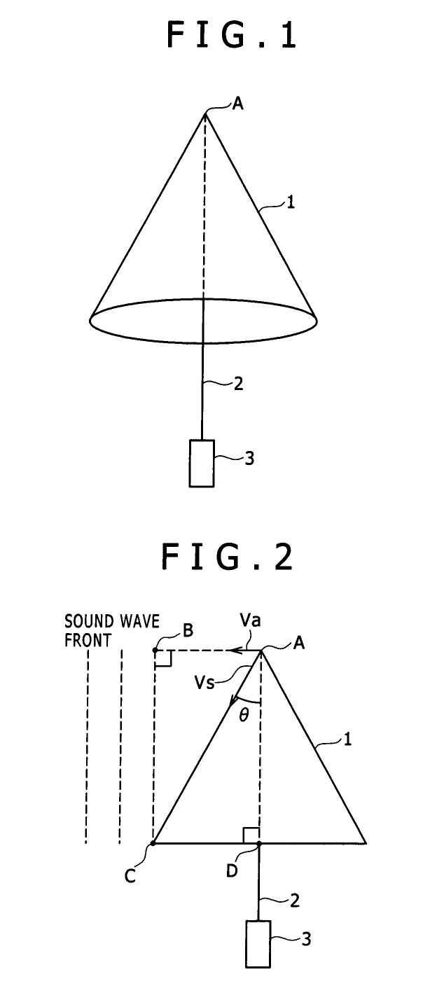

FIG. 1 is a view for illustrating the external appearance of an excitation type speaker device according to a first preferred embodiment of the present invention. As shown in FIG. 1, the speaker device according to the first preferred embodiment is composed of a conical diaphragm 1, a vibration transmitting member 2, and a vibrating element (actuator) 3.

The conical diaphragm 1 is used as an acoustic diaphragm, and it is formed of epoxy resin, for example, so as to have a circular conical shape. In the first preferred embodiment, the conical diaphragm 1 has a thickness of about 3 mm, for example, and the inside of the conical diaphragm 1 is vacant. That is, the conical diaphragm 1 has an isosceles triangular shape as viewed in side elevation, and the circular base of the conical diaphragm 1 is formed with a circular (exactly round) opening.

When a perpendicular is dropped from the vertex A of the conical diaphragm 1 to the base thereof, this perpendicular passes through the center of the circular base of the conical diaphragm 1. Accordingly, the perpendicular from the vertex A of the conical diaphragm 1 to the base thereof is identical with the axis of the conical diaphragm 1.

As shown in FIG. 1, the vibration transmitting member 2 is provided so that one end of the vibration transmitting member 2 is in contact with the vertex A of the conical diaphragm 1 from the inside of the conical diaphragm 1. Further, the vibrating element 3 is provided so that it is in contact with the other end of the vibration transmitting member 2, thereby exciting the conical diaphragm 1.

The vibration transmitting member 2 is formed from a so-called piano wire or a carbon fiber wire, and has a diameter of about 1 mm to several mm, for example. As shown in FIG. 1, the vibration transmitting member 2 is located on the axis of the conical diaphragm 1 to connect the vertex A of the conical diaphragm 1 and the vibrating element 3.

While one end of the vibration transmitting member 2 is in contact with the vertex A of the conical diaphragm 1 as mentioned above, this contact may be made in various manners. For example, in the case that the conical diaphragm 1 itself has a certain degree of weight, the conical diaphragm 1 may be simply put on the vibration transmitting member 2 in the manner shown in FIG. 1.

However, the conical diaphragm 1 and the vibration transmitting member 2 are preferably fixed to each other in order to efficiently transmit the vibration through the vibration transmitting member 2 to the conical diaphragm 1.

For example, the conical diaphragm 1 and the vibration transmitting member 2 may be fixed by threaded engagement in such a manner that a screw hole is formed at the vertex A of the conical diaphragm 1 and screw threads are formed at one end of the vibration transmitting member 2. In this case, the screw hole may be directly opened at the vertex A of the conical diaphragm 1 or a pipe having the screw hole may be bonded to the vertex A of the conical diaphragm 1. Any other forming methods for the screw hole may be used.

Further, the conical diaphragm 1 and the vibration transmitting member 2 may be rigidly bonded at the vertex A by using a melted resin or an adhesive. Any other fixing methods for the conical diaphragm 1 and the vibration transmitting member 2 may be adopted.

The vibration transmitting member 2 is a rodlike member, and its sectional shape is not limited. For example, cylindrical, prismatic, and platelike members may be used.

The vibration transmitting member 2 is formed of a material in which “internal loss” is low and “sound velocity” is high. For example, this material includes steel (e.g., piano wire) and carbon fiber.

The term of “internal loss” literally means loss when vibration propagates in a solid. In other words, “internal loss” indicates whether or not vibration is easily transmitted. Accordingly, low “internal loss” means low propagation loss, which means that “vibration propagates efficiently.” Further, the term of “sound velocity” means a transmission velocity of elastic wave propagating in an elastic body or a continuum.

In consideration of the “internal loss” and the “sound velocity,” the most desirable material (substance) for the vibration transmitting member 2 must have good vibration propagation efficiency, that is, the “internal loss” must be low in this material.

Further, the “sound velocity” must be high in this material in order to minimize a time delay from a start point (excitation point) of the vibration transmitting member 2 to an end point (a point farthest from the excitation point) thereof.

In this manner, the material of the vibration transmitting member 2 may be suitably selected and used according to the “internal loss” and the “sound velocity.”

The vibrating element (actuator) 3 functions to receive an acoustic signal as an object to be reproduced and generate vibration according to this acoustic signal. As hereinafter described, various actuators such as a piezoelectric actuator, electrodynamic actuator, and super magnetostrictive actuator may be used as the vibrating element 3.

The piezoelectric actuator is an actuator using an element capable of causing displacement by applying a voltage thereto. The electrodynamic actuator is an actuator having a coil and a magnet for producing vibration by using a current. The super magnetostrictive actuator is an actuator using a super magnetostrictor capable of changing its dimensions according to an external magnetic field. In the speaker device according to the first preferred embodiment, a super magnetostrictive actuator is used as the vibrating element 3.

Accordingly, vibration according to an acoustic signal as an object to be reproduced is applied from the vibrating element 3 to the lower end of the vibration transmitting member 2. This vibration is next transmitted through the vibration transmitting member 2 to the vertex A of the conical diaphragm 1.

Thereafter, compression wave according to the vibration transmitted through the vibration transmitting member 2 to the vertex A of the conical diaphragm 1 propagates in the conical diaphragm 1 at a sound velocity inherent in the material (epoxy resin) of the conical diaphragm 1. During the course of propagation of this compression wave, a force perpendicular to the conical diaphragm 1 is generated according to a Poisson ratio inherent in the solid (the conical diaphragm 1 formed of epoxy resin).

As a result, vibration perpendicular to the conical diaphragm 1 is produced by this force perpendicular to the conical diaphragm 1, and this vibration resultantly becomes sound wave. That is, sound according to the vibration transmitted through the vibration transmitting member 2 is radiated from the conical diaphragm 1.

In the conical diaphragm 1 according to the first preferred embodiment, the angle θ between the axis of the conical diaphragm 1 and the side surface of the conical diaphragm 1 is set in consideration of a time difference in sound wave radiation timing between the vertex A kept in contact with the vibration transmitting member 2 and a position farthest from the vertex A.

FIG. 2 is a side view of the speaker device according to the first preferred embodiment shown in FIG. 1. As described above, the conical diaphragm 1 has an isosceles triangular shape as viewed in side elevation.

As shown in FIG. 2, the vibration transmitting member 2 is located on the axis of the conical diaphragm 1. One end of the vibration transmitting member 2 is in contact with the vertex A of the conical diaphragm 1. Accordingly, vibration according to an acoustic signal is produced by the vibrating element 3, and this vibration is transmitted through the vibration transmitting member 2 to the vertex A of the conical diaphragm 1.

Accordingly, the excitation point in the conical diaphragm 1 is the vertex A, and sound is radiated at once from the vertex A of the conical diaphragm 1. On the other hand, the vibration transmitted to the vertex A of the conical diaphragm 1 propagates in the conical diaphragm 1 to reach a position C at the lower end of the side surface of the conical diaphragm 1, i.e., a position farthest from the vertex A, and sound is subsequently radiated from the position C.

As shown in FIG. 2, a position B is defined as the intersection between a line passing through the vertex A of the conical diaphragm 1 and extending parallel to the base of the conical diaphragm 1 and a line passing through the position C and extending perpendicular to the base of the conical diaphragm 1. Further, a position D is defined as the intersection between the axis of the conical diaphragm 1 and the base of the conical diaphragm 1.

Unless the vibration from the vertex A of the conical diaphragm 1 reaches the position C through the conical diaphragm 1 to radiate sound from the position C at the time the sound radiated from the vertex A reaches the position B, an ideal cylindrical wave cannot be formed around the conical diaphragm 1.

The angle θ between the axis of the conical diaphragm 1 and the side surface of the conical diaphragm 1 is set so that the vibration from the vertex A of the conical diaphragm 1 reaches the position C through the conical diaphragm 1 at the time the sound radiated from the vertex A reaches the position B.

As shown in FIG. 2, the angle θ is also expressed as the angle between the axis AD of the conical diaphragm 1 and an edge AC of the side surface of the conical diaphragm 1 (a line connecting the vertex A and the position C).

In setting the angle θ, a sound velocity Va in the air (transmission velocity of sound propagating in the air) and a sound velocity Vs in the conical diaphragm 1 (transmission velocity of elastic wave propagating in the conical diaphragm 1) are important.

As shown in FIG. 2, the sound traveling from the vertex A of the conical diaphragm 1 toward the position B propagates in the air, so that this sound propagates at the sound velocity Va in the air. On the other hand, the vibration (elastic wave) traveling from the vertex A of the conical diaphragm 1 toward the position C propagates at the sound velocity Vs in the conical diaphragm 1.

The sound velocity Va in the air is about 340 m/sec, and the sound velocity in epoxy resin forming the conical diaphragm 1 is about 1700 m/sec. Accordingly, the angle θ is set so that the time elapsed until the sound radiated from the vertex A propagates in the air at the sound velocity of 340 m/sec to reach the position B is equal to the time elapsed until the vibration from the vertex A propagates in the epoxy resin at the sound velocity of 1700 m/sec to reach the position C.

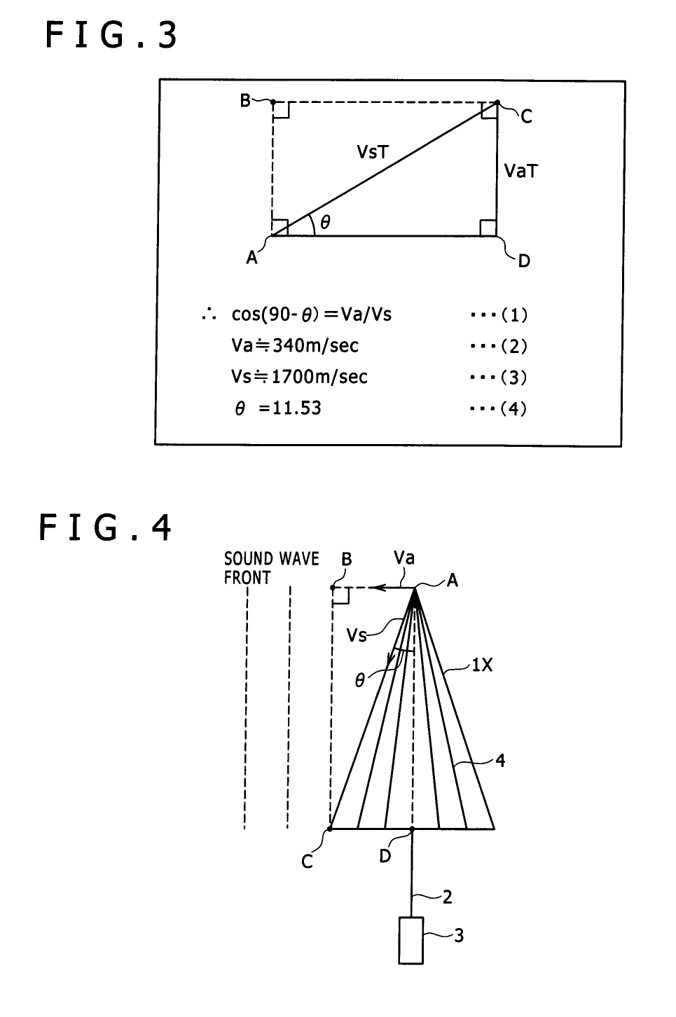

FIG. 3 is a diagram for illustrating how to obtain the angle θ between the axis AD of the conical diaphragm 1 and the edge AC of the side surface of the conical diaphragm 1. That is, FIG. 3 corresponds to a quadrangular part surrounded by the vertex A, the position B, the position C, and the position D shown in FIG. 2.

In FIG. 3, the quadrangle formed by the points A, B, C, and D is a rectangle whose interior angles are right angles, so that the side AB is equal to the side DC, and the side AD is equal to the side BC. Therefore, in FIG. 3, any two sides and the angle formed therebetween in the triangle ABC are congruent to those in the triangle CDA. That is, it can be said that the triangle ABC and the triangle CDA are congruent to each other.

Also in FIG. 3, reference character Va denotes the sound velocity in the air and reference character Vs denotes the sound velocity in the epoxy resin. Further, the angle θ is the angle formed between the axis AD of the conical diaphragm 1 and the edge AC of the side surface of the conical diaphragm 1. Further, reference character T denotes time.

As shown in FIG. 3, the distance between the points A and B is represented by VaT (the product of Va and T), and the distance between the points A and C is represented by VsT (the product of Vs and T). The angle θ can be obtained by Eq. (1) shown in FIG. 3.

In Eq. (1) shown in FIG. 3, the time T is commonly included in the denominator and in the numerator and it is therefore canceled by reduction. Further, Eq. (1) shown in FIG. 3 is equivalent to sin θ=Va/Vs.

By inserting the sound velocity Va in the air of Eq. (2) and the sound velocity Vs in the epoxy resin of Eq. (3) into the Eq. (1) shown in FIG. 3, the angle θ can be calculated to 11.53 degrees as shown in Eq. (4).

Accordingly, as shown in FIGS. 1 to 3, the conical diaphragm 1 is formed so that the angle θ between the axis AD of the conical diaphragm 1 and the edge AC of the side surface of the conical diaphragm 1 becomes 11.53 degrees.

As a result, an ideal cylindrical wave can be formed around the conical diaphragm 1 as represented by a sound wave front shown by dashed lines in FIG. 2. Accordingly, it can be said that the speaker device according to the first preferred embodiment shown in FIGS. 1 to 3 is completely nondirectional. In other words, the sound radiated from the speaker device according to the first preferred embodiment can be well heard at any position around this speaker device.

### Modification of First Preferred Embodiment

FIG. 4 is a view for illustrating a modification of the speaker device according to the first preferred embodiment. As shown in FIG. 4, the speaker device of this modification also includes a conical diaphragm 1X, a vibration transmitting member 2, and a vibrating element 3.

The vibration transmitting member 2 and the vibrating element 3 of the speaker device shown in FIG. 4 are respectively similar to the corresponding members of the speaker device shown in FIGS. 1 and 2. The conical diaphragm 1X is similar in shape to the conical diaphragm 1 shown in FIGS. 1 and 2, but different in internal configuration.

More specifically, the conical diaphragm 1X in this modification shown in FIG. 4 is formed of epoxy resin and has a circular conical shape as similar to the conical diaphragm 1 shown in FIGS. 1 and 2. However, as shown in FIG. 4, a plurality of in-diaphragm vibration transmitting members 4 are embedded in the conical diaphragm 1X.

Each in-diaphragm vibration transmitting member 4 is formed of titanium, for example, and has a rodlike shape. The plural in-diaphragm vibration transmitting members 4 are embedded in the side surface of the conical diaphragm 1X so as to radially extend from the vertex A of the conical diaphragm 1X.

Accordingly, the plural in-diaphragm vibration transmitting members 4 are in proximity to the vibration transmitting member 2 at the vertex A of the conical diaphragm 1X. For example, the plural in-diaphragm vibration transmitting members 4 may be in direct contact with the vibration transmitting member 2 at the vertex A of the conical diaphragm 1X.

The “internal loss” in titanium is 0.002 and the sound velocity in titanium is 4950 m/sec. In contrast, the sound velocity in epoxy resin is 1700 m/sec as mentioned above. Thus, the sound velocity in titanium is about three times the sound velocity in epoxy resin.

Accordingly, the sound velocity in the conical diaphragm 1X in which the plural in-diaphragm vibration transmitting members 4 of titanium are embedded so as to extend radially from the vertex A as shown in FIG. 4 is higher than the sound velocity in the conical diaphragm 1 formed of epoxy resin only as shown in FIGS. 1 and 2.

Accordingly, as compared with the speaker device shown in FIGS. 1 and 2, the speaker device according to this modification shown in FIG. 4 has an advantage such that the angle θ between the axis AD of the conical diaphragm 1X and the edge AC of the side surface of the conical diaphragm 1X can be reduced. As a result, slimming of the conical diaphragm can be realized.

In the speaker device according to this modification shown in FIG. 4, the sound velocity Vs in the conical diaphragm 1X is obtained in consideration of the number of the in-diaphragm vibration transmitting members 4 embedded in the conical diaphragm 1X and the sound velocity in the in-diaphragm vibration transmitting members 4.

Then, the angle θ between the axis AD of the conical diaphragm 1X and the edge AC of the side surface of the conical diaphragm 1X can be suitably obtained by the calculation shown in FIG. 3, thereby forming the conical diaphragm 1X.

While in this modification the in-diaphragm vibration transmitting members 4 are formed of titanium in this modification, the material of the in-diaphragm vibration transmitting members 4 is not limited. That is, other various materials may be used as the in-diaphragm vibration transmitting members 4. For example, a so-called piano wire formed of steel and a wire formed of carbon fiber may be used.

Further, while the in-diaphragm vibration transmitting members 4 are embedded in the conical diaphragm in this modification, the fixing method for the in-diaphragm vibration transmitting members 4 to the conical diaphragm is not limited. For example, the in-diaphragm vibration transmitting members 4 may be closely attached to the surface of the conical diaphragm.

### Cylindrical Wave Formed by Speaker Device according to First Preferred Embodiment

According to the first preferred embodiment shown in FIGS. 1 to 4, a nondirectional speaker device capable of forming an ideal cylindrical wave can be realized as mentioned above.

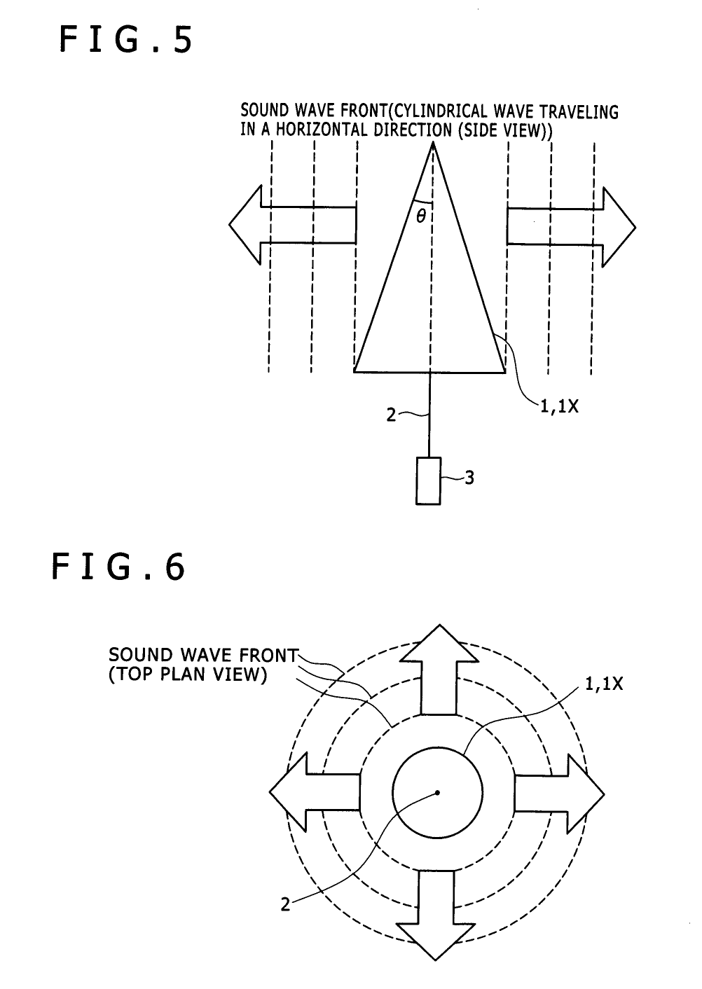

FIG. 5 is a side view for illustrating a sound wave front generated by the speaker device according to the first preferred embodiment shown in FIGS. 1 to 4 as viewed in side elevation of the speaker device, and FIG. 6 is a top plan view for illustrating the sound wave front generated by the speaker device according to the first preferred embodiment shown in FIGS. 1 to 4 as viewed in top plan of the speaker device.

As shown by dashed lines in FIG. 5 showing a side elevation of the speaker device according to the first preferred embodiment, it is possible to form a sound wave front extending perpendicular to the base of the cylindrical diaphragm 1 or 1X and traveling in a horizontal direction.

As shown by dashed lines in FIG. 6 showing a top plan of the speaker device according to the first preferred embodiment, it is possible to form an ideal cylindrical wave having the center at the vertex A of the conical diaphragm 1 or 1X and traveling in a horizontal direction around the conical diaphragm 1 or 1X.

As apparent from FIGS. 5 and 6, a completely nondirectional speaker device can be realized by using the conical diaphragm in which the angle θ between the axis AD and the edge AC of the side surface is suitably adjusted.

[Configuration of Vibrating Element 3]

There will now be described a specific configuration of the vibrating element (actuator) 3 used in the speaker device according to the first preferred embodiment. As described above, the vibrating element 3 in the first preferred embodiment is provided by a super magnetostrictive actuator.

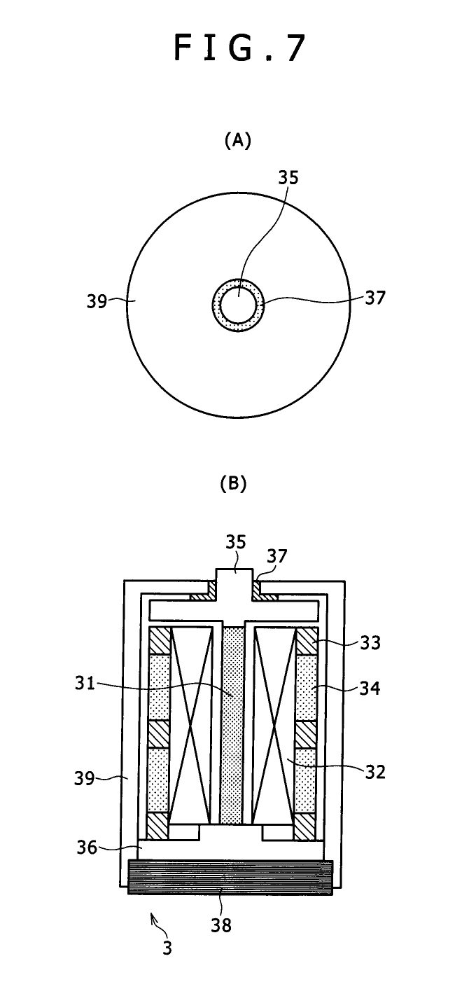

Accordingly, the configuration of a super magnetostrictive actuator will now be described. FIG. 7 is views for illustrating the configuration of a super magnetostrictive actuator used as the vibrating element 3 in the speaker device according to this preferred embodiment. More specifically, FIG. 7(A) is a top plan view of the super magnetostrictive actuator and FIG. 7(B) is a sectional side view of the super magnetostrictive actuator in the case that a preload is applied to a super magnetostrictor.

As the body of the vibrating element (actuator), a solenoid coil 32 is arranged around a rodlike super magnetostrictor 31, and a magnet 33 and a yoke 34 are arranged around the solenoid coil 32.

A driving rod 35 is connected to one end of the super magnetostrictor 31, and a fixed plate 36 is mounted to the other end of the super magnetostrictor 31.

The body of the vibrating element (actuator) having these components is enclosed in an outer case 39 formed of aluminum, for example, in such a manner that the front end of the driving rod 35 projects out of the outer case 39.

Further, a damping member 37 formed of silicone rubber, for example, is mounted on the driving rod 35, and a screw 38 is inserted in the outer case 39 on the back side of the fixed plate 36, thereby applying a preload to the super magnetostrictor 31.

In the speaker devices shown in FIGS. 1, 2, and 4, the vibrating element 3 having the configuration shown in FIG. 7 is provided so as to come into contact with the lower end of the vibration transmitting member 2.

In this case, the vibrating element 3 has a wide magnetic field range where a magnetostriction value changes linearly with a change in controlling field and also has magnetostriction characteristics such that a change in magnetostriction value with a change in controlling field in this magnetic field range is large. For example, the load applied to the super magnetostrictor 31 can be adjusted by compression given by a coil spring or the like located on the lower side of the vibrating element 3.

[Specific Configuration of Speaker Device]

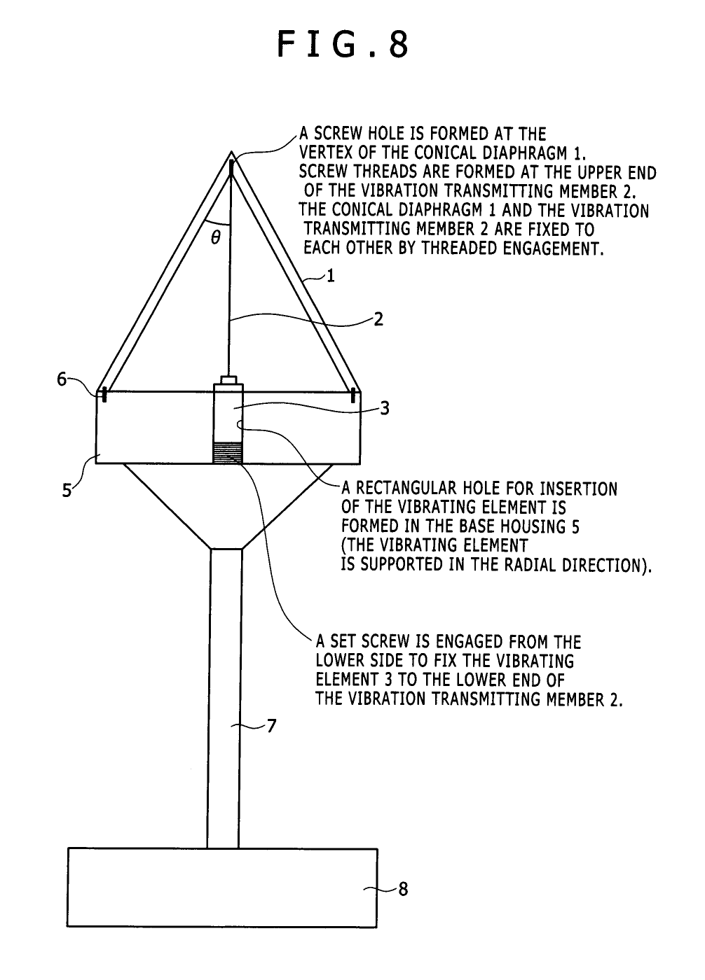

A specific configuration of the first preferred embodiment mentioned above will now be described. FIG. 8 is a view for illustrating a specific configuration of the speaker device according to the first preferred embodiment. More specifically, FIG. 8 is a sectional view taken along a plane passing through the center of the speaker device.

As described above with reference to FIGS. 1 to 4, the speaker device according to the first preferred embodiment basically includes the conical diaphragm 1, the vibration transmitting member 2, and the vibrating element 3. The conical diaphragm 1 of the speaker device having the configuration shown in FIG. 8 is formed of epoxy resin, acrylic resin, etc. and has a thickness (wall thickness) of about 3 mm.

As described above with reference to FIG. 3, the conical diaphragm 1 shown in FIG. 8 is formed so that the angle θ between the axis of the conical diaphragm 1 and the edge of the side surface of the conical diaphragm 1 is suitably set according to the sound velocity Va in the air and the sound velocity Vs in the conical diaphragm 1.

A screw hole is formed at the vertex of the conical diaphragm 1 of the speaker device shown in FIG. 8 so as to open to the inside of the conical diaphragm 1. One end of the vibration transmitting member 2 is threadedly engaged with this screw hole formed at the vertex of the conical diaphragm 1.

The vibration transmitting member 2 shown in FIG. 8 is a rodlike member formed from a so-called piano wire or a carbon fiber wire, and has a length substantially equal to the height of the conical diaphragm 1. Further, screw threads for engaging the screw hole formed at the vertex of the conical diaphragm 1 are formed at one end of the vibration transmitting member 2.

Accordingly, one end of the vibration transmitting member 2 is fixed to the vertex of the conical diaphragm 1 by threaded engagement such that the screw threads formed at one end of the vibration transmitting member 2 are engaged with the screw hole formed at the vertex of the conical diaphragm 1.

The vibrating element 3 is located so as to come into contact with the other end of the vibration transmitting member 2. As shown in FIG. 8, all of the conical diaphragm 1, the vibration transmitting member 2, and the vibrating element 3 are supported to a base housing 5 in order to bring the vibrating member 3 into proper contact with the vibration transmitting member 2 and maintain this contact.

The base housing 5 is provided to fix the conical diaphragm 1, the vibration transmitting member 2, and the vibrating element 3 thereto. The base housing 5 is desirably heavy so that the base housing 5 itself does not vibrate. Accordingly, the base housing 5 is formed of metal such as brass and aluminum.

The base housing 5 is a cylindrical member having an upper surface having an area equal to or slightly larger than the area of the base of the conical diaphragm 1. However, the shape of the base housing 5 is not limited to a cylindrical shape, but the base housing 5 may be a prismatic member having an upper surface having a size that can entirely cover the base of the conical diaphragm 1.

In this manner, the base of the conical diaphragm 1 is covered with the upper surface of the base housing 5 to thereby enclose the space inside the conical diaphragm 1. Accordingly, the sound wave generated inside the conical diaphragm 1 can be shut off.

In other words, the interference between the sound wave generated from the outside surface of the conical diaphragm 1 and the sound wave generated inside the conical diaphragm 1 can be prevented, thereby forming a better sound field.

As shown in FIG. 8, the upper surface of the base housing 5 is fixed to the lower end of the side surface of the conical diaphragm 1 by means of screws 6. For example, the base housing 5 is fixed to the conical diaphragm 1 by means of the screws 6 at eight positions 45° spaced apart from each other along the outer circumference of the base of the conical diaphragm 1.

In addition to the screws 6, a rubber member of a felt member may be interposed between the base housing 5 and the conical diaphragm 1 or an adhesive may be applied therebetween to thereby improve the contact condition between the base housing 5 and the conical diaphragm 1. Any other methods for improving the contact condition between the base housing 5 and the conical diaphragm 1 may be suitably used.

A vertical hole for mounting the vibrating element 3 is formed at a central portion of the base housing 5. By mounting the vibrating element 3 in the vertical hole formed at the central portion of the base housing 5, the vibrating element 3 is supported in the radial direction (in the horizontal direction), so that radial vibration of the vibrating element 3 is prevented.

As shown in FIG. 8, the vibrating element 3 is pressed upward (toward the vibration transmitting member 2) by a set screw from the lower side of the base housing 5. Accordingly, the vibrating element 3 can be pressed by a suitable force against the lower end (head) of the vibration transmitting member 2 fixed to the conical diaphragm 1 provided on the base housing 5.

Accordingly, the vibrating element 3 is supported in its radial direction by the base housing 5 and also kept in pressure contact with the vibration transmitting member 2 in its longitudinal direction by a suitable pressing force. As a result, the vibration generated by the vibrating element 3 according to an acoustic signal is suitably transmitted through the vibration transmitting member 2 to the vertex A of the conical diaphragm 1.

As shown in FIG. 8, the base housing 5 is placed on a supporting table composed of a leg 7 and a bottom plate 8 and fixed to the supporting table. Thus, the base housing 5 is supported at a predetermined height from a floor surface. Accordingly, an ideal cylindrical wave traveling in a horizontal direction from the conical diaphragm 1 can be formed in a space (sound field space) around the conical diaphragm 1.

While the conical diaphragm 1 and the vibration transmitting member 2 are fixed to each other by threaded engagement in the specific configuration shown in FIG. 8, the fixing method for the conical diaphragm 1 and the vibration transmitting member 2 is not limited. For example, the vibration transmitting member 2 may be arranged so as to simply come into contact with the vertex of the conical diaphragm 1 because the conical diaphragm 1 and the base housing 5 are firmly connected to each other by the screws 6 as shown in FIG. 8.

As another modification, various resins or adhesives may be used to fix the vibration transmitting member 2 to the vertex of the conical diaphragm 1. That is, it is essential that the vibration transmitting member 2 is kept in contact with the vertex of the conical diaphragm 1 in such a manner that the vibration can be properly transmitted to the vertex of the conical diaphragm 1.

[Control of Traveling Direction of Sound Wave Front]

As described above with reference to FIG. 5, a cylindrical wave extending perpendicular to the base of the conical diaphragm 1 and traveling in a horizontal direction is formed by suitably setting the angle θ between the axis of the conical diaphragm 1 and the edge of the side surface of the conical diaphragm 1 in the speaker device according to the first preferred embodiment.

However, there is a case that the speaker device according to the first preferred embodiment is located on the lower side with respect to a user (listener) or conversely located on the upper side with respect to the user. In such a case, it is sometimes desired to upward incline or downward incline the traveling direction of the cylindrical wave.

However, if the speaker device itself, or the conical diaphragm 1 itself is inclined as a whole, the traveling direction of the cylindrical wave on the upward or downward inclined side becomes opposite to that on the downward or upward inclined side because the sound wave front is formed around the speaker device over the entire circumference thereof.

More specifically, in the case that the speaker device shown in FIG. 5 is inclined downward to the left, the sound wave front travels downward on the left side of the speaker device, whereas the sound wave front travels upward on the right side of the speaker device.

In the speaker device according to the first preferred embodiment, the traveling direction of the sound wave front can be inclined downward or upward over the entire circumference of the conical diaphragm 1 by adjusting the angle θ between the axis of the conical diaphragm 1 and the edge of the side surface of the conical diaphragm 1.

As in the first preferred embodiment shown in FIGS. 1 to 3, the speaker device in this case includes a conical diaphragm 1 formed of epoxy resin, a vibration transmitting member 2 formed from a so-called piano wire, and a vibrating element 3.

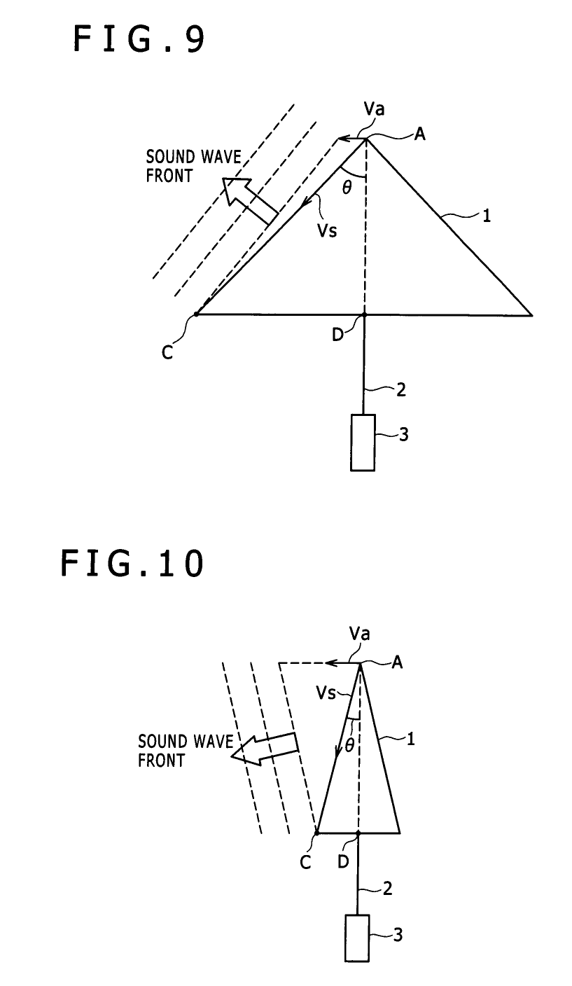

FIG. 9 is a view for illustrating the case of upward inclining the traveling direction of the sound wave front of sound radiated from the conical diaphragm 1.

In the speaker device according to the first preferred embodiment shown in FIGS. 2 and 3, sound can be radiated so as to form the sound wave front perpendicular to the base of the conical diaphragm 1 by setting the angle θ between the axis of the conical diaphragm 1 and the edge of the side surface of the conical diaphragm 1 to 11.53 degrees.

To upward direct the sound wave front, the angle θ between the axis of the conical diaphragm 1 and the edge of the side surface of the conical diaphragm 1 is set to a value greater than 11.53 degrees. In the case that the angle θ is increased in this manner, the lower end C of the side surface of the conical diaphragm 1 is moved away from the axis AD as shown in FIG. 9.

As apparent from the comparison between FIG. 5 and FIG. 9, the position C is farther from the axis AD in the case of FIG. 9 by increasing the angle θ with the position of the vertex A of the conical diaphragm 1 unchanged. As a result, the traveling direction of the sound wave front is inclined upward.

In this manner, the traveling direction of the sound wave front is inclined upward over the entire circumference of the conical diaphragm 1. Accordingly, the speaker device in this case is suitable in the case that it is located on the lower side with respect to the user's head, e.g., located in the vicinity of the user's feet.

FIG. 10 is a view for illustrating the case of downward inclining the traveling direction of the sound wave front of sound radiated from the conical diaphragm 1.

To downward direct the sound wave front, the angle θ between the axis of the conical diaphragm 1 and the edge of the side surface of the conical diaphragm 1 is set to a value less than 11.53 degrees. In the case that the angle θ is increased in this manner, the lower end C of the conical diaphragm 1 is moved toward the axis AD as shown in FIG. 10.

As apparent from the comparison between FIG. 5 and FIG. 9, the position C is nearer to the axis AD in the case of FIG. 10 by decreasing the angle θ with the position of the vertex A of the conical diaphragm 1 unchanged. As a result, the traveling direction of the sound wave front is inclined downward.

In this manner, the traveling direction of the sound wave front is inclined downward over the entire circumference of the conical diaphragm 1. Accordingly, the speaker device in this case is suitable in the case that it is located on the upper side with respect to the user's head, e.g., located in the vicinity of a ceiling.

Thus, the radiating direction of sound wave can be finely adjusted by adjusting the properly determined angle θ according to the location of the speaker device.

### Second Preferred Embodiment

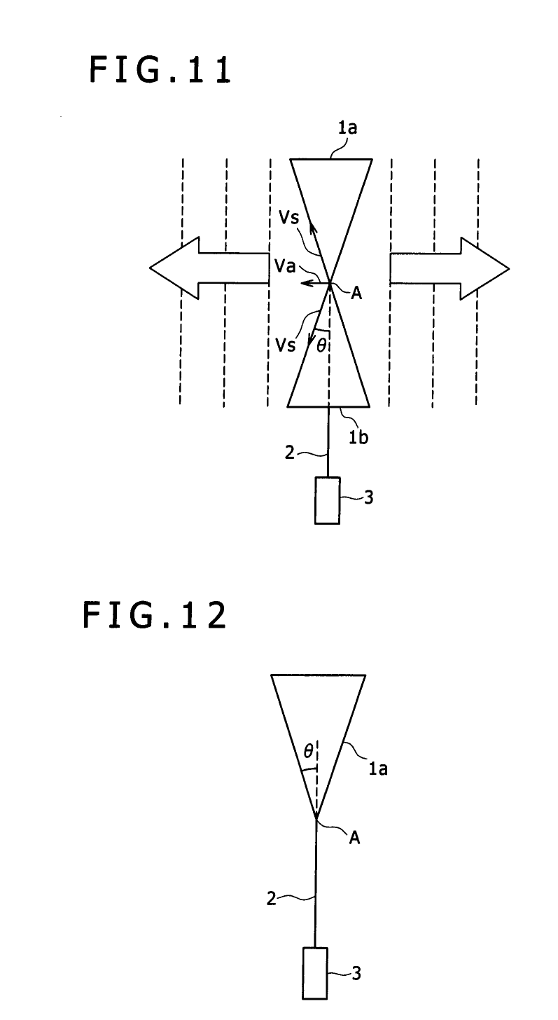

FIG. 11 is a view for illustrating an excitation type speaker device according to a second preferred embodiment of the present invention. More specifically, FIG. 11 is a side view of the speaker device according to the second preferred embodiment.

In FIG. 11, parts similar to those of the speaker device according to the first preferred embodiment shown in FIGS. 1 to 3 are denoted by the same reference numerals and the detailed description thereof will be omitted herein.

The speaker device according to the second preferred embodiment shown in FIG. 11 is composed of two conical diaphragms 1a and 1b, a vibration transmitting member 2, and a vibrating element 3.

As in the case of the conical diaphragm 1 according to the first preferred embodiment shown in FIG. 3, each of the conical diaphragms 1a and 1b is formed so that the angle θ between the axis and the side surface of the conical diaphragm 1a or 1b is adjusted according to the sound velocity in the air and the sound velocity in the conical diaphragm 1a or 1b.

That is, each of the conical diaphragms 1a and 1b can form a cylindrical wave extending perpendicular to the base of the conical diaphragm 1a or 1b and traveling parallel to the base of the conical diaphragm 1a or 1b. As in the first preferred embodiment, each of the conical diaphragms 1a and 1b is formed of epoxy resin, for example.

As shown in FIG. 11, the speaker device according to the second preferred embodiment is configured by connecting the conical diaphragm 1a and the conical diaphragm 1b in such a manner that the axes of the conical diaphragms 1a and 1b are aligned to each other and the vertices of the conical diaphragms 1a and 1b are opposed to each other.

One end of the vibration transmitting member 2 is in contact with the vertices of the conical diaphragms 1a and 1b connected together as mentioned above. That is, one end of the vibration transmitting member 2 is in contact with the vertices of the conical diaphragms 1a and 1b so that vibration can be transmitted to both the conical diaphragms 1a and 1b.

As in the first preferred embodiment, the vibrating element 3 is in contact with the other end of the vibration transmitting member 2.

Accordingly, the vibration generated by the vibrating element 3 according to an acoustic signal is transmitted through the vibration transmitting member 2 to the conical diaphragms 1a and 1b. A cylindrical wave extending perpendicular to the bases of the conical diaphragms 1a and 1b and traveling parallel to the bases of the conical diaphragms 1a and 1b is formed around the conical diaphragms 1a and 1b.

By connecting the two conical diaphragms 1a and 1b as shown in FIG. 11, the height of each of the conical diaphragms 1a and 1b can be suppressed and the radial size of the base of each of the conical diaphragms 1a and 1b can therefore be suppressed.

That is, if a certain degree of height is intended to be obtained by the single conical diaphragm 1 as shown in FIGS. 1 and 2, the base of the conical diaphragm 1 becomes relatively large. To the contrary, by using the two conical diaphragms 1a and 1b to realize the same height as that of the conical diaphragm 1, the height of each of the conical diaphragms 1a and 1b can be reduced to the half of the height of the conical diaphragm 1.

In this case, the base of each of the conical diaphragms 1a and 1b can be reduced in size as compared with the case that the same height is realized by the single conical diaphragm. Thus, the radial size of the base can be suppressed by using the two conical diaphragms 1a and 1b, thereby forming a slim (slender) speaker device.

Conversely, it is possible to realize a speaker device which can form a cylindrical wave having an axial length increased by axially arranging a plurality of conical diaphragms.

That is, a plurality of sets of conical diaphragms 1a and 1b shown in FIG. 11 may be connected in the vertical direction. By connecting a single vibration transmitting member to the vertices of all the conical diaphragms connected above, it is possible to realize a speaker device which can form a cylindrical wave having an increased axial length.

[Change in Orientation of Conical Diaphragm]

While the speaker device according to the second preferred embodiment shown in FIG. 11 employs the two conical diaphragms 1a and 1b, a speaker device employing only the conical diaphragm 1a whose base is oriented upward may be formed.

FIG. 12 is a view for illustrating such a speaker device employing only the conical diaphragm 1a whose base is oriented upward. The speaker device shown in FIG. 12 includes the conical diaphragm 1a, a vibration transmitting member 2, and a vibrating member 3 similar to those of the speaker device according to the second preferred embodiment shown in FIG. 11.

In other words, the speaker device shown in FIG. 12 has a configuration obtained by removing the conical diaphragm 1b from the speaker device shown in FIG. 11. The speaker device shown in FIG. 12 is different from the speaker device shown in FIGS. 1 and 2 in only the point that the base of the conical diaphragm 1a is oriented upward. Accordingly, as in the speaker device shown in FIGS. 1 and 2, a cylindrical wave similar to that obtained in the first preferred embodiment can be formed around the conical diaphragm 1a.

The property of the cylindrical wave formed by the speaker device shown in FIG. 12 in which the base of the conical diaphragm is oriented upward is the same as the property of the cylindrical wave formed by the speaker device shown in FIGS. 1 and 2 in which the base of the conical diaphragm is oriented downward.

Accordingly, by providing the speaker device shown in FIG. 12 and the speaker device shown in FIGS. 1 and 2, the user can select any preferred one of these two speaker devices.

Also in the speaker devices shown in FIGS. 11 and 12, a plurality of in-diaphragm vibration transmitting members formed of titanium, for example, may be embedded in or attached to the conical diaphragms 1a and 1b as in the configuration shown in FIG. 4.

With this configuration, the sound velocity in the conical diaphragms 1a and 1b can be increased, so that the angle θ between the axis and the side surface of each of the conical diaphragms 1a and 1b can be reduced to thereby slim the conical diaphragms.

### Third Preferred Embodiment

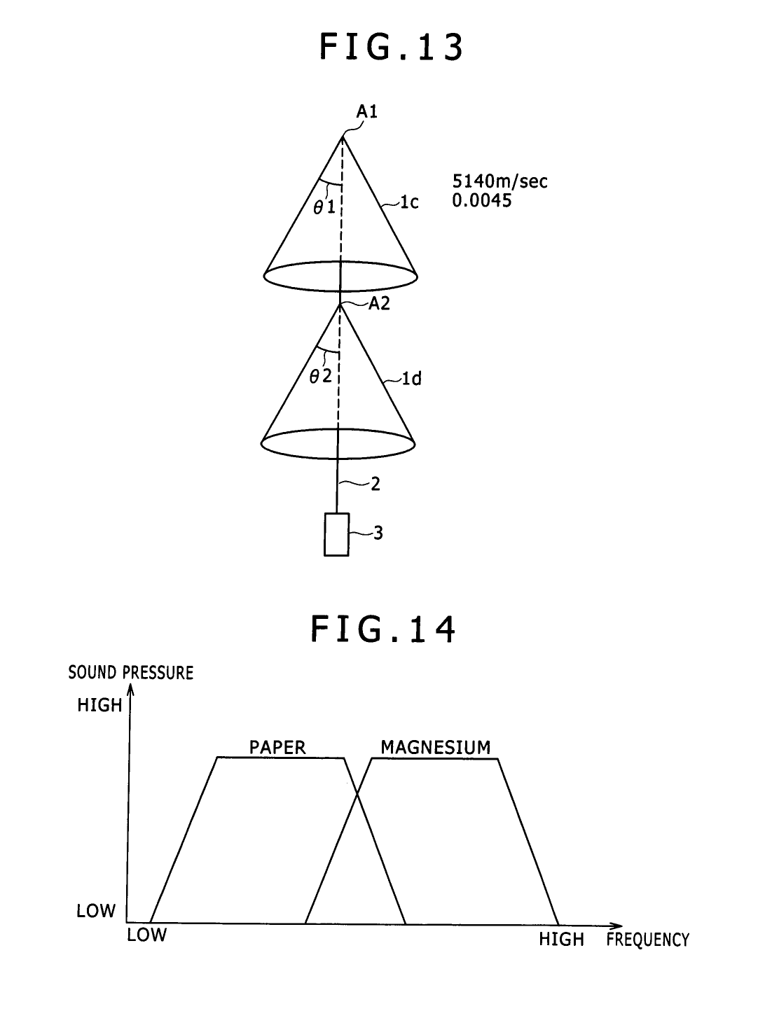

FIGS. 13 to 16 are views for illustrating various configurations of a speaker device according to a third preferred embodiment of the present invention. The speaker device according to the third preferred embodiment employs a plurality of conical diaphragms as similar to the speaker device according to the second preferred embodiment shown in FIG. 12, but different from the speaker device according to the second preferred embodiment in the way of arrangement of the conical diaphragms.

### First Example of Third Preferred Embodiment

FIG. 13 is a view for illustrating a speaker device according to a first example of the third preferred embodiment. As shown in FIG. 13, the speaker device according to this example includes a conical diaphragm 1c formed of magnesium and a conical diaphragm 1d formed of paper (e.g., cone paper).

As in the conical diaphragm 1 according to the first preferred embodiment shown in FIG. 3, the angle θ1 between the axis of the conical diaphragm 1c and the edge of the side surface of the conical diaphragm 1c is adjusted according to the sound velocity in the air and the sound velocity in the conical diaphragm 1c. Similarly, the angle θ2 between the axis of the conical diaphragm 1d and the edge of the side surface of the conical diaphragm 1d is adjusted according to the sound velocity in the air and the sound velocity in the conical diaphragm 1d.

Accordingly, as in the first preferred embodiment, the conical diaphragm 1c can form a cylindrical wave extending perpendicular to the base of the conical diaphragm 1c and traveling parallel to the base of the conical diaphragm 1c (in the horizontal direction). Similarly, the conical diaphragm 1d can form a cylindrical wave extending perpendicular to the base of the conical diaphragm 1d and traveling parallel to the base of the conical diaphragm 1d (in the horizontal direction).

The “internal loss” in magnesium is 0.0045, and the “sound velocity” in magnesium is about 5000 m/sec as similar to titanium. Further, in addition, the “internal loss” in paper (cone paper) is 0.04, and the “sound velocity” in paper is 1650 m/sec.

Although the angle θ1 in the conical diaphragm 1c and the angle θ2 in the conical diaphragm 1d are shown to be substantially equal to each other in FIG. 13, the angle θ1 in the conical diaphragm is formed of magnesium is smaller than the angle θ2 in the conical diaphragm 1d formed of paper.

As shown in FIG. 13, the conical diaphragms 1c and 1d are arranged in tandem and the vertices of the conical diaphragms 1c and 1d are connected to the vibration transmitting member 2. Various connecting methods for the vertices of the conical diaphragms 1c and 1d to the vibration transmitting member 2 may be used. For example, as described above, the vertices of the conical diaphragms 1c and 1d and the vibration transmitting member 2 may be fixed by threaded engagement or by using a resin or adhesive.

The vibrating element 3 is in contact with the lower end of the vibration transmitting member 2. Accordingly, the vibration generated by the vibrating element 3 according to an acoustic signal is transmitted through the vibration transmitting member 2 to the conical diaphragms 1c and 1d.

Accordingly, cylindrical waves extending perpendicular to the bases of the conical diaphragms 1c and 1d and traveling parallel to the bases of the conical diaphragms 1c and 1d can be formed around the conical diaphragms 1c and 1d.

The acoustic diaphragm 1c formed of magnesium has a relatively low internal loss, and it well responds to vibration in a high-frequency portion (high-frequency region). Accordingly, the acoustic diaphragm is used to radiate a high-frequency sound.

On the other hand, the acoustic diaphragm 1d formed of paper has an internal loss higher than that of magnesium, and it well responds to vibration in a low-frequency portion (low-frequency region). Accordingly, the acoustic diaphragm 1d is used to radiate a low-frequency sound.

FIG. 14 is a graph for illustrating the vibration characteristics of magnesium and paper. As shown in FIG. 14, the acoustic diaphragm 1c formed of magnesium responds to vibration having high frequencies, thereby radiating a high-frequency sound at a high sound pressure. In contrast, as shown in FIG. 14, the acoustic diaphragm 1d formed of paper responds to vibration having low frequencies, thereby radiating a low-frequency sound at a high sound pressure.

Accordingly, by using the acoustic diaphragm 1c of magnesium and the acoustic diaphragm 1d of paper, the reproducing frequency characteristics of the speaker device can be extended toward both the high-frequency region and the low-frequency region. That is, the reproducing frequency characteristics can be totally extended to form a good reproduced sound field.

### Second Example of Third Preferred Embodiment

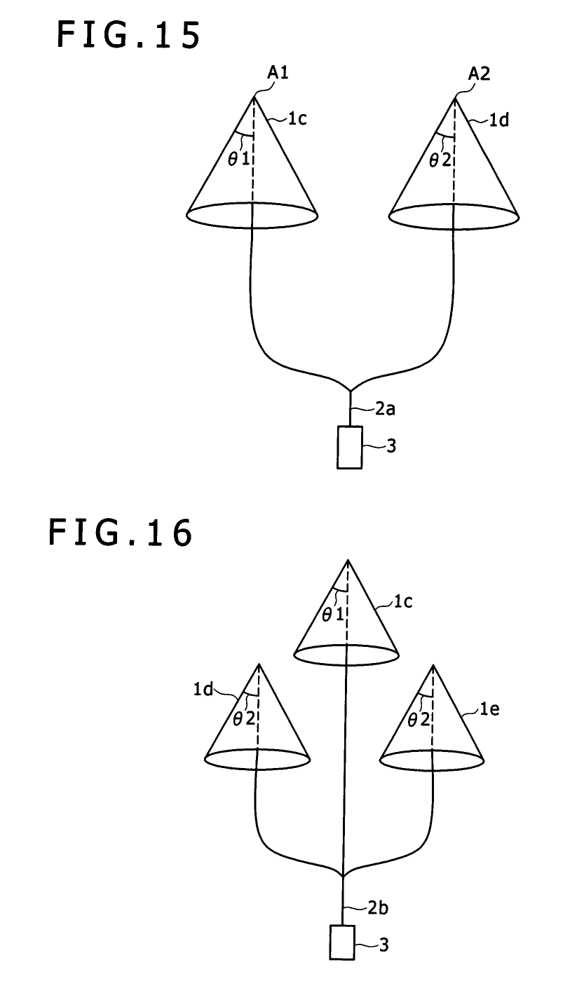

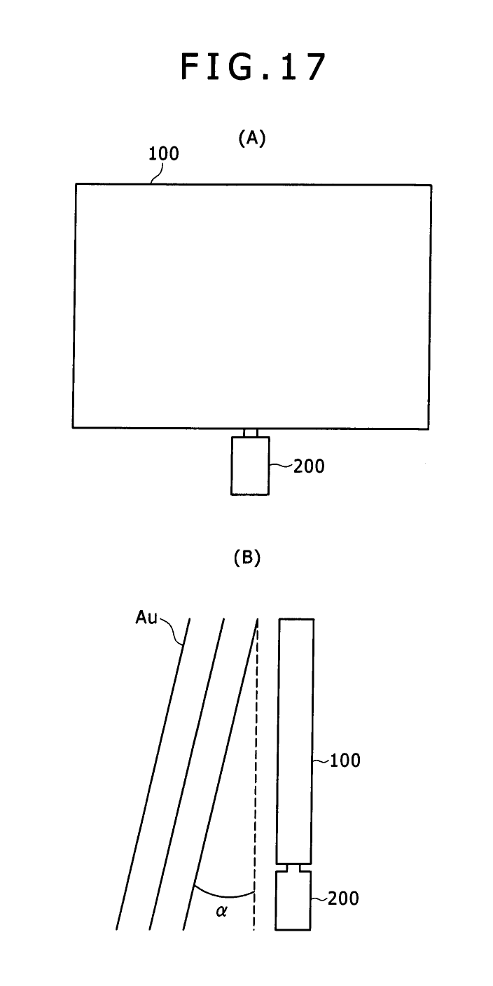

FIG. 15 is a view for illustrating a speaker device according to a second example of the third preferred embodiment. As in the second example shown in FIG. 13, the speaker device according to the second example includes a conical diaphragm 1c formed of magnesium and a conical diaphragm 1d formed of paper (e.g., cone paper).

As in the conical diaphragms 1c and 1d of the speaker device according to the first example shown in FIG. 13, the conical diaphragms 1c and 1d of the speaker device shown in FIG. 15 are formed so that the angles θ1 and θ2 are set according to the calculation shown in FIG. 3.

Accordingly, as in the first preferred embodiment, the conical diaphragm 1c can form a cylindrical wave extending perpendicular to the base of the conical diaphragm 1c and traveling parallel to the base of the conical diaphragm 1c (in the horizontal direction). Similarly, the conical diaphragm 1d can form a cylindrical wave extending perpendicular to the base of the conical diaphragm 1d and traveling parallel to the base of the conical diaphragm 1d (in the horizontal direction).

As shown in FIG. 15, a vibration transmitting member 2a is branched to two portions, which are respectively connected to the conical diaphragms 1c and 1d. That is, the vertices of the conical diaphragms 1c and 1d are respectively connected to the upper ends of the two branched portions of the vibration transmitting member 2a.

Also in this example, various connecting methods for the vertices of the conical diaphragms 1c and 1d to the vibration transmitting member 2a may be used. For example, as described above, the vertices of the conical diaphragms 1c and 1d and the vibration transmitting member 2a may be fixed by threaded engagement or by using a resin or adhesive. Further, the two branched portions of the vibration transmitting member 2a are curved so as to minimize the attenuation of the vibration.

The vibrating element 3 is in contact with the lower end of the vibration transmitting member 2a. Accordingly, the vibration generated by the vibrating element 3 according to an acoustic signal is transmitted through the vibration transmitting member 2 to the conical diaphragms 1c and 1d.

Accordingly, cylindrical waves extending perpendicular to the bases of the conical diaphragms 1c and 1d and traveling parallel to the bases of the conical diaphragms 1c and 1d can be formed around the conical diaphragms 1c and 1d.

As in the speaker device shown in FIG. 13, the acoustic diaphragm 1c of magnesium and the acoustic diaphragm 1d of paper are used to thereby extend the reproducing frequency characteristics of the speaker device toward both the high-frequency region and the low-frequency region. That is, the reproducing frequency characteristics can be totally extended to form a good reproduced sound field.

In this example, the two branched portions of the vibration transmitting member 2a are respectively connected to the two acoustic diaphragms 1c and 1d, so that the vibration can be equally (uniformly) transmitted to the two acoustic diaphragms 1c and 1d.

### Third Example in the Case of Using Plural Acoustic Diaphragms

FIG. 16 is a view for illustrating a speaker device according to a third example of the third preferred embodiment. The speaker device according to the third example shown in FIG. 16 includes a conical diaphragm 1c formed of magnesium and two conical diaphragms 1d and 1e formed of paper (e.g., cone paper). That is, the speaker device in this case has the totally three conical diaphragms 1c, 1d, and 1e.

As in the conical diaphragms 1c and 1d of the speaker devices according to the first and second examples of the third preferred embodiment, the conical diaphragms 1c, 1d, and 1e of the speaker device shown in FIG. 16 are formed so that the angles θ1 and θ2 are set according to the calculation shown in FIG. 3.

Accordingly, as in the first preferred embodiment, the conical diaphragm 1c can form a cylindrical wave extending perpendicular to the base of the conical diaphragm 1c and traveling parallel to the base of the conical diaphragm 1c (in the horizontal direction). Similarly, the conical diaphragm 1d can form a cylindrical wave extending perpendicular to the base of the conical diaphragm 1d and traveling parallel to the base of the conical diaphragm 1d (in the horizontal direction). Similarly, the conical diaphragm 1e can form a cylindrical wave extending perpendicular to the base of the conical diaphragm 1e and traveling parallel to the base of the conical diaphragm 1e (in the horizontal direction).

As shown in FIG. 16, a vibration transmitting member 2b is branched to three portions, which are respectively connected to the conical diaphragms 1c, 1d, and 1e. That is, the vertices of the conical diaphragms 1c, 1d, and 1e are respectively connected to the upper ends of the three branched portions of the vibration transmitting member 2b.

Also in this example, various connecting methods for the vertices of the conical diaphragms 1c, 1d, and 1e to the vibration transmitting member 2b may be used. For example, as described above, the vertices of the conical diaphragms 1c, 1d, and 1e and the vibration transmitting member 2b may be fixed by threaded engagement or by using a resin or adhesive. As in the case of the vibration transmitting member 2a according to the second example shown in FIG. 15, the branched portions of the vibration transmitting member 2b are curved so as to minimize the attenuation of the vibration.

The vibrating element 3 is in contact with the lower end of the vibration transmitting member 2b. Accordingly, the vibration generated by the vibrating element 3 according to an acoustic signal is transmitted through the vibration transmitting member 2 to the conical diaphragms 1c, 1d, and 1e.

Accordingly, cylindrical waves extending perpendicular to the bases of the conical diaphragms 1c, 1d, and 1e and traveling parallel to the bases of the conical diaphragms 1c, 1d, and 1e can be formed around the conical diaphragms 1c, 1d, and 1e.

As in the speaker device shown in FIG. 13, the acoustic diaphragm 1c of magnesium and the acoustic diaphragm 1d of paper are used to thereby extend the reproducing frequency characteristics of the speaker device toward both the high-frequency region and the low-frequency region. That is, the reproducing frequency characteristics can be totally extended to form a good reproduced sound field.

In this example, the three branched portions of the vibration transmitting member 2a are respectively connected to the acoustic diaphragm 1c, acoustic diaphragm 1d, and the conical diaphragm 1e, so that the vibration can be equally (uniformly) transmitted to the three acoustic diaphragms 1c, 1d, and 1e.

Also in the speaker devices according to the third preferred embodiment, a plurality of in-diaphragm vibration transmitting members formed of titanium, for example, may be embedded in or attached to the conical diaphragms 1a and 1b as in the configuration shown in FIG. 4.

With this configuration, the sound velocity in the conical diaphragms 1a and 1b can be increased, so that the angle θ between the axis and the side surface of each of the conical diaphragms 1a and 1b can be reduced to thereby slim the conical diaphragms.

### Other Examples in the Case of Using Plural Acoustic Diaphragms

A suitable number of acoustic diaphragms may be used. In this case, the plural acoustic diaphragms may be individually vibrated by different actuator. Further, as described above with reference to FIGS. 15 and 16, the vibration from a single actuator may be transmitted through a branched vibration transmitting member to the plural acoustic diaphragms.

Further, the plural acoustic diaphragms may have different sizes. For example, the height of the acoustic diaphragm for radiating a low-frequency sound may be made larger than the height of the acoustic diaphragm for radiating a high-frequency sound. Conversely, the height of the acoustic diaphragm for radiating a high-frequency sound may be made larger than the height of the acoustic diaphragm for radiating a low-frequency sound.

Further, the materials of the plural acoustic diaphragms are not limited to magnesium and paper. For example, all of the plural acoustic diaphragms may be formed of magnesium or all of the plural acoustic diaphragms may be formed of paper. Further, any materials other than magnesium and paper may be used for the plural acoustic diaphragms. For example, plastic, glass, and various fibers may be used for the plural acoustic diaphragms.

### Effect of Preferred Embodiments

According to the preferred embodiments mentioned above, it is possible to realize a nondirectional speaker device which can radiate a cylindrical wave traveling in the horizontal direction. As compared with the conventional excitation type speaker device for forming a cylindrical wave not traveling in the horizontal direction, an effect of more suppressing the attenuation of a sound pressure according to distance can be expected. That is, it is possible to realize a nondirectional speaker device which can form a better sound field.

[Method of this Invention]

As apparent from the above description of the first to third preferred embodiments, the method of this invention is characterized in that in forming the speaker device including the conical diaphragm 1, the vibration transmitting member 2, and the vibrating element 3, the angle θ between the perpendicular dropped from the vertex of the conical diaphragm 1 to the base of the conical diaphragm 1 and the side surface of the conical diaphragm 1 is set so that the distance traveled by the sound radiated from the vertex of the conical diaphragm 1 is equal to the distance traveled by the sound radiated from the end of the side surface of the conical diaphragm 1 farthest from the vertex with the same timing as that of the sound radiated from the vertex.

A specific setting method for the angle θ has been described with reference to FIG. 3. The speaker devices described with reference to FIGS. 1, 2, 4, 8, 11 to 13, 15, and 16 are basically formed by using the speaker device forming method of the present invention.

[Others]

[Material, Size, Shape, etc. of Components]

As described above, various materials and sizes may be used for the conical diaphragms 1, 1a, 1b, 1c, 1d, and 1e. In particular, the height of each conical diaphragm may be set variously, and the size of the base of each conical diaphragm is determined according to the height.

Further, the conical diaphragms 1, 1a, 1b, 1c, 1d, and 1e in the above preferred embodiments have a circular conical shape. However, the shape of the acoustic diaphragm in the present invention is not limited to a circular conical shape. That is, a pyramidal acoustic diaphragm may also be used. In other words, acoustic diaphragms having various pyramidal shapes may be used. More specifically, acoustic diaphragms having the shapes of triangular pyramid, quadrangular pyramid, pentagonal pyramid, etc. may be used.

In this case, the radiating direction (traveling direction) of the sound is influenced by the orientation of the side surfaces of the pyramid. However, by increasing the number of the side surfaces of the pyramid as in octagonal pyramid and hexadecagonal pyramid, the directivity of the speaker device can be made close to a nondirectional property.

Basically, a regular pyramid is preferably used as the pyramid. However, any pyramids other than a regular pyramid may be used as the acoustic diaphragm in the present invention. In this case, by suitably setting the angle θ between the axis and each side surface, the sound wave front can be suitably controlled.

Further, various materials, shapes, and sizes may be used for the vibration transmitting member. Further, the number of conical acoustic diaphragms, the number of vibration transmitting members, and the number of actuators may be suitable.

Thus, the material, shape, and size of the conical acoustic diaphragm, the material, shape, and size of the vibration transmitting member, the number of conical acoustic diaphragms, the number of vibration transmitting members, and the number of actuators may be suitably selected in such a range that the target sound characteristics (frequency characteristics, time response, phase characteristics, etc.) of sound to be radiated can be realized.

Further, various actuators such as a piezoelectric actuator, electrodynamic actuator, and super magnetostrictive actuator may be used as the actuator.

Further, various kinds of paper may be used as the material of the acoustic diaphragm. For example, drawing paper, kraft paper, and various kinds of converted paper may be used.

[Configurations of Vibration Transmitting Member]

The length of the vibration transmitting member 2 is not limited to a preliminarily fixed length. That is, the length of the vibration transmitting member 2 may be adjustable. For example, the structure of the vibration transmitting member may be formed as a so-called antenna rod structure such that a plurality of vibration transmitting members different in thickness are joined so as to be expanded and contracted.

As a modification, a plurality of vibration transmitting members each having screw threads at both ends (external threads at one end and internal threads at the other end) may be prepared, and these external threads and internal threads of the vibration transmitting members may be engaged as required to thereby form a single vibration transmitting member.

Thus, the vibration transmitting member may have an expandable structure such that it can be expanded and contracted as required or may have a connectable structure such that the parts of the vibration transmitting member can be connected as required.

### EXPLANATION OF REFERENCE SYMBOLS

1: Conical diaphragm
1a, 1b: Conical diaphragm
1c, 1d, 1e: Conical diaphragm
2, 2a, 2b: Vibration transmitting member
3: Vibrating element
4: In-diaphragm vibration transmitting member
5: Base housing
6: Screw
7: Leg
8: Bottom plate

1. A speaker device comprising:
an acoustic diaphragm having a conical shape such that a perpendicular dropped from a vertex to a base passes through the center of the base;
a vibrating element for receiving an acoustic signal to be reproduced and generating vibration according to the acoustic signal; and
a vibration transmitting member having one end supported to the vertex of the acoustic diaphragm having the conical shape and the other end to be excited by the vibrating element;
wherein the angle θ between the perpendicular dropped from the vertex of the acoustic diaphragm to the base of the acoustic diaphragm and a side surface of the acoustic diaphragm is set so that the distance traveled by a sound radiated from the vertex of the acoustic diaphragm is equal to the distance traveled by a sound radiated from an end of the side surface of the acoustic diaphragm farthest from the vertex of the acoustic diaphragm with the same timing as that of the sound radiated from the vertex.

2. The speaker device according to claim 1, wherein the angle θ is obtained by cos(90−θ)=Va/Vb, where Va is the sound velocity in the air and Vs is the sound velocity in the acoustic diaphragm having the conical shape.

3. The speaker device according to claim 1, wherein the side surface of the acoustic diaphragm having the conical shape is provided with one or more other vibration transmitting members in which the sound velocity is higher than that in the acoustic diaphragm.

4. The speaker device according to claim 1, wherein the acoustic diaphragm having the conical shape comprises a plurality of conical acoustic diaphragms having the conical shape and connected to the vibration transmitting member.

5. The speaker device according to claim 4, wherein the vibration transmitting member has a plurality of branched portions respectively corresponding to the plurality of conical acoustic diaphragms having the conical shape.

6. The speaker device according to claim 4, wherein one or more of the plurality of conical acoustic diaphragms having the conical shape and the remaining conical acoustic diaphragms are formed of different materials.

7. The speaker device according to claim 1, wherein the acoustic diaphragm having the conical shape comprises a circular conical acoustic diaphragm having a circular base.

8. The speaker device according to claim 1, wherein the acoustic diaphragm having the conical shape comprises a pyramidal acoustic diaphragm having a polygonal base.

9. The speaker device according to claim 1, wherein the vibrating element comprises a super magnetostrictive actuator.

10. The speaker device according to claim 1, wherein the vibrating element comprises a piezoelectric actuator.

11. The speaker device according to claim 1, wherein the vibrating element comprises an electrodynamic actuator.

12. A forming method for a speaker device comprising an acoustic diaphragm having a conical shape such that a perpendicular dropped from a vertex to a base passes through the center of the base, a vibrating element for receiving an acoustic signal to be reproduced and generating vibration according to the acoustic signal, and a vibration transmitting member having one end supported to the vertex of the acoustic diaphragm having the conical shape and the other end to be excited by the vibrating element;
wherein the angle θ between the perpendicular dropped from the vertex of the acoustic diaphragm to the base of the acoustic diaphragm and a side surface of the acoustic diaphragm is set so that the distance traveled by a sound radiated from the vertex of the acoustic diaphragm is equal to the distance traveled by a sound radiated from an end of the side surface of the acoustic diaphragm farthest from the vertex of the acoustic diaphragm with the same timing as that of the sound radiated from the vertex.
